(19) United States
(12) Patent Application Publication
(10) Pub. No.: US 2006/0267782 A1
(43) Pub. Date: Nov. 30, 2006

(54) Cargo screening apparatus

(76) Inventor: Eric David Stavoe, Phoenix, AZ (US)

Correspondence Address: Eric D. Stavoe;#3, 14045 N. 7th Street, Phoenix, AZ, 85022, US

(21) Appl. No.: 11/440,171

(22) Filed: May 24, 2006

Related U.S. Application Data
(60) Provisional application No. 60/685,555, filed on May 27, 2005.

(51) Int. Cl. G08B 17/12

(52) U.S. Cl. 340/600; 340/568.1

(57) ABSTRACT

The apparatus of the invention detects and reports the presence of electromagnetic energy which may interfere with flight systems, be associated with devices restricted from use onboard aircraft or may be used as a triggering means for a hazardous device. The apparatus includes a chamber (10) for containing object to be tested in an environment shielded from externally generated electromagnetic energy. The invention further includes equipment for receiving (30), detecting (40), and reporting (50) the presence of electromagnetic energy within the chamber (10). The invention is primarily for use in determining the presence of hazards in aircraft cargo but can easily be adapted for other uses.

### CROSS REFERENCE TO RELATED APPLICATIONS

This application claims the benefit of provisional patent application Ser. No. 60/685,555, filed 2005 May 27 by the present inventor.

### FEDERALLY SPONSORED RESEARCH

Not Applicable

### SEQUENCE LISTING OR PROGRAM

Not Applicable

### BACKGROUND OF THE INVENTION—FIELD OF INVENTION

The present invention relates generally to electronic apparatus and methodology for the detection of unauthorized devices that generate electromagnetic energy. The particular methods and apparatus described relate to the detection of electromagnetic energy in aircraft cargo or luggage. However, the invention as described is not limited to this particular application or use.

### BACKGROUND OF THE INVENTION—PRIOR ART

The safety and security of commercial airline travel is a long term and growing concern. Since the events of Sep. 11^{th}, 2001 the security of the United States aviation system has come under intense scrutiny. Government officials have given speeches, appointed commissions and contracted studies indicating that there are vulnerabilities in the security of the aviation system.

The 9/11 Commission Report, CRS Report for Congress, updated Sep. 11^{th}, 2003, Transportation Security Administration's (TSA) Air Cargo Strategic Plan, Nov. 17^{th}, 2003 and GAO AVIATION SECURITY Federal Action Needed to Strengthen Air Cargo Security, October 2005, have all noted the need for improved cargo screening and the challenges in achieving this objective. As a result of this need many current technologies have been directed at finding the explosives in passenger baggage or cargo.

Numerous attempts have been made in the prior art to detect and prevent the introduction of hazardous devices onto aircraft. Trained dog have been used to identify the presence of contraband and explosives and in some cases have been successful. Specifically designed explosive detection devices are commercially available and have been proposed for use in aircraft and luggage handling areas.

U.S. Pat. No. 3,075,461 (the ‘461’ patent) issued Jan. 23^{rd}, 1963 to Irwin Ehlmann, utilizes sweep frequency transmitter designed to detonate radio frequency sensitive blasting caps. The ‘461’ patent is impractical because detonation of the blasting cap causes a dangerous explosion, destroys the object and endangers property, life, and limb of those in the vicinity when detonation is achieved. Furthermore the ‘461’ patent is only effective when the detonator is sensitive to a specific frequency. Other patents recommend the construction of test chamber for creating a partial vacuum to simulate a high altitude environment. U.S. Pat. No. 2,917,927 (the ‘927’ patent) issued Dec. 22^{nd}, 1959 to George F. Clark is for one such chamber. This test chamber is of little value due to the fact that although the chamber may activate a device there is no way to determine the timing of the detonation once activated. Without identifying the presence of the device the likelihood of collateral damage would almost be certain.

U.S. Pat. No. 5,274,356 (the ‘356’ patent) issued to Todd L. Taricco on Dec. 28^{th}, 1993 addresses the problem of finding and triggering pressure sensitive explosives. This invention has several disadvantages. The ‘356’ patent device uses a series of simulated takeoffs and landings, via changing the air pressure, to attempt to trigger an atmospheric pressure sensitive trigger device. The ultimate result of the invention is that if such a bomb is in a cargo container it will be activated and explode prior to being loaded onto an aircraft. This process destroys the container, the contents and the items in the surrounding area. In a heavily populated area such as a warehouse, industrial zone, Aircraft Operating Area (AOA) or tarmac the resulting explosion would almost certainly result in property damage, injury or the death of people in the surrounding area. Additionally, this process is excessively time intensive in a system which handles millions of pieces of cargo daily.

U.S. Pat. No. 5,086,300 (the ‘300’ patent), issued to George A. Ashmore on Feb. 4^{th}, 1992 also addresses identifying pressure sensitive explosive devices using an atmospheric pressure chamber. In the ‘300’ patent the device scans for pre-programmed radio frequency emissions generated by a timing device triggered by the atmospheric testing. There are several problems with this approach. One problem is that if the trigger is not atmospheric, this device is not designed to detect or identify it. A second problem is that utilizing pre-programmed frequencies limits the parameters of the screening process resulting in gaps in the screening procedure. A third problem with the “300” patent is that it targets only the radio frequency range of the electromagnetic spectrum and does not address hazardous devices which are not part of an explosive train.

In both of the preceding patents, the ‘356’ and ‘300’, there is a broader problem with the assumptions regarding atmospheric testing methods and its effectiveness. In both of the methods the atmospheric testing procedure is designed to activate the explosive or fusing mechanism in order to detect it. The ultimate outcome of this process results in the detonation of the explosive. Once an explosive device is activated the timeline to a detonation would be unpredictable and the probability of collateral damage would be likely.

An additional problem with the ‘356’ and ‘300’ inventions is that the long cycle time used to process cargo utilizing this method is prohibitive in an industry that processed millions of items each day. Finally, the overall assumption that a barometric bomb, set for a high altitude detonation would be an effective threat does not recognize that the cargo holds of modern commercial aircraft are pressurized and that the flight officers have the ability to control the air pressure within the cargo compartment.

The ‘300’ patent also proposes an embodiment with a detachable hand unit. Detecting and identifying specific low level radio emissions in an electromagnetic rich environment such as a modern airport, outside of a controlled environment, would be inaccurate and impractical. Radar, communications equipment, industrial machinery, vehicles, computers, cellular telephones and other electrical devices generate ambient electric signals which would interfere with the accuracy of detecting specific electromagnetic energy outside a controlled environment. As a result the ability to detect and identify specific electromagnetic energy in an uncontrolled environment, such as an airport, would be unreliable.

The present invention seeks to provide a means to detect electromagnetic energy and electronic devices which may have the potential to interfere with flight control systems or may be used in an activation sequence for an explosive or other hazardous device.

### BACKGROUND OF INVENTION—OBJECTS AND ADVANTAGES

Accordingly, besides the objects and advantages of the cargo screening apparatus described in my above patent, several objects and advantages of the present invention are:

a) to provide a cargo screening apparatus to improve the safety of air travel;

b) to provide a cargo screening apparatus which could be manufactured economically;

c) to provide a cargo screening apparatus which could be produced in large quantities quickly;

d) to provide for a cargo screening apparatus which could be rapidly deployed to airports and cargo facilities throughout the United States and around the world;

e) to provide a cargo screening apparatus which provides for an economical method of screening cargo prior to loading it onboard an aircraft or other vessels;

f) to provide a cargo screening apparatus which provides an efficient method of screening cargo prior to loading it onboard an aircraft or other vessel;

g) to provide a cargo screening apparatus which provides an accurate method of screening cargo prior to loading it onboard an aircraft or other vessel;

h) to provide for a cargo screening apparatus which is easy to operate;

i) to provide for a cargo screening apparatus which would require limited training to operate;

j) to provide a cargo screening apparatus that could be utilized alone, or in conjunction with other screening methods, to provide an additional layer of security to travelers;

k) to provide a cargo screening apparatus that could be utilized alone, or in conjunction with other screening methods, to provide an additional layer of security to identify suspect freight being shipped into the United States, or other countries;

l) to provide a cargo screening apparatus that could be utilized alone, or in conjunction with other screening methods, to provide an additional layer of security to identify suspect freight being shipped outbound from ports, including foreign ports;

m) to provide a cargo screening apparatus which would provide an additional means of identifying high risk cargo for additional screening;

n) to provide a cargo screening apparatus which could be utilized for screening items other than cargo.

Further objects and advantages will become apparent from a consideration of the ensuing description and drawings.

### SUMMARY

The present invention addresses the problem of finding an economically viable method of screening aircraft cargo for electromagnetic energy which could interfere with aircraft flight control systems or be generated from hazardous items. Additionally, the present invention provides a screening mechanism for devices which might be used as a remote trigger for an explosive or other hazardous device. Therefore, the goal of the present invention is to detect within a sealed container the presence of electromagnetic energy which may indicate the presence of a hazardous material or a device that could pose a hazard or be used as an electronic triggering mechanism for an explosive or other hazardous device, and to do so in a manner that is more efficient and effective than currently existing technology.

In accordance with these objectives the present invention represents a state of the art electromagnetic energy detection apparatus. The present invention is composed of an apparatus that contains a shielded enclosure, sealable openings, internal antenna, electromagnetic energy detector and reporting device.

The invention includes a shielded enclosure which is constructed in such a way that when sealed the interior is insulated from externally generated electromagnetic energy. In the preferred embodiment of the invention, the enclosure is large enough to contain multiple aircraft unit load devices (ULDs) and cargo palletized freight shipments. Additionally, the enclosure contains sealable openings that are large enough to allow ingress and egress of the objects to be tested.

The chamber includes an opening, or a plurality of openings, which permit ingress and egress of objects to be tested. The openings are sealable and when sealed prohibit the intrusion of externally generated electromagnetic energy from the interior of the chamber.

Contained within the enclosure is an antenna, or plurality of antennae, to receive any electromagnetic energy present. Connected to the antenna is a detector means, such as a spectrum analyzer, radio frequency detection unit, superheterodyne receiver, radio frequency counter or other type device.

The apparatus also includes a human interface means such as a visual or audio alert to convey the results of the data collection to a human operator.

### DRAWINGS—FIGURES

The drawings provide a further understanding of the present invention:

FIG. 1 is a perspective of the shielded chamber;

FIG. 2 is a cutaway perspective of the shielded chamber showing the interior space and a sealed opening at the far end of the chamber;

FIG. 3 is a block diagram showing sequential steps in the screening process;

DRAWINGS - Reference Numerals

| | Reference | |
|---|---|---|
| FIG. | Number | Description |
| 1 | 10 | Chamber |
| 1 | 20 | Door - Shown partially closed |
| 1 | 30 | Interior Antenna |
| 1 | 40 | Detection Device |
| 1 | 50 | Human Interface |
| 2 | 10 | Chamber |
| 2 | 20 | Door - Shown partially closed |
| 2 | 25 | Door - Shown sealed |
| 2 | 30 | Interior Antenna |
| 2 | 40 | Detection Device |
| 2 | 50 | Human Interface |
| 3 | | Block Flow Chart of sequence of steps |
| | | in method process |

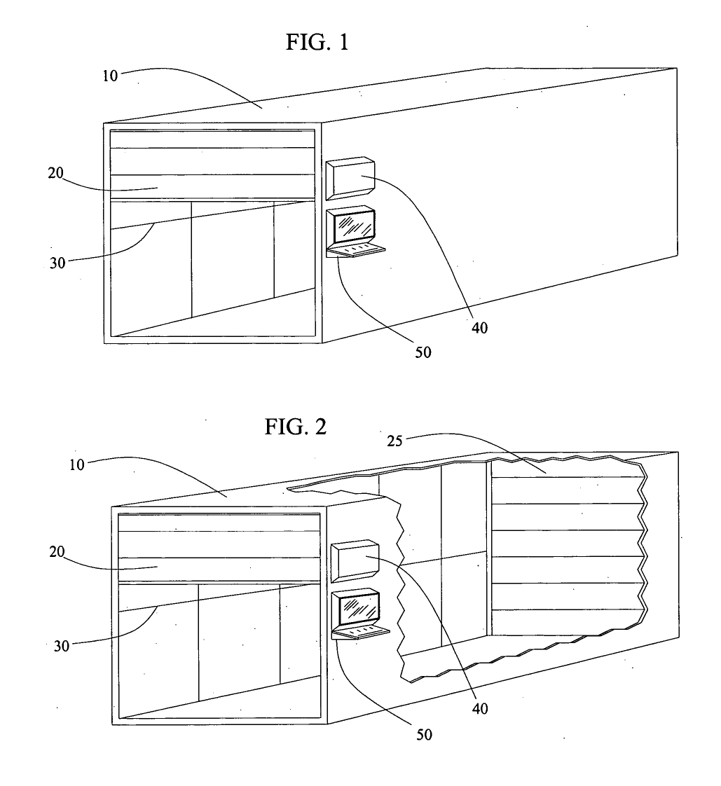

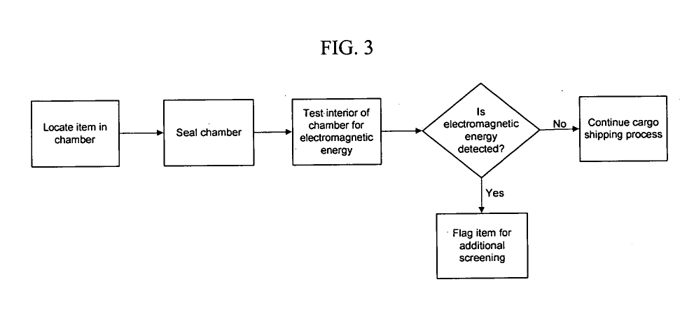

### DETAILED DESCRIPTION—FIG. 1, FIG. 2, FIG. 3 AND PREFERRED EMBODIMENT

The invention is electromagnetic energy detection and reporting apparatus. The electronic and mechanical components of the apparatus are more fully described below. The description provided is for the purposes of explanation and specific component arrangements and other details presented may be modified in various alternative designs and embodiments. Design information provided is to promote an understanding of the invention; however, it will be apparent to those skilled in the art that the invention may be practiced without specific details. Manufacturing methods and systems, known to those in the field, are not described in detail in order not to obscure the invention.

FIG. 1, the invention comprises:
a shielded enclosure, that when sealed, is capable of preventing the intrusion of externally generated electromagnetic energy to the interior of the chamber 10, door(s) 20 & 25 of sufficient size to permit ingress and egress of test object(s), an interior antenna 30,
a data detection device 40 used to detect electromagnetic energy,
a man-machine interface device 50.

In FIG. 1, the enclosure 10 is shown to be of sufficient size and dimension that it is capable of completely enclosing the test object to be screened. In the preferred embodiment, the interior of the test chamber 10 is large enough to completely enclose the antenna 30, internal components of the invention and the object to be screened. The preferred embodiment also provides for openings 20 and 25 located at various locations in the test chamber and of such size and dimension to permit ingress, egress, and a linear flow of objects through the test chamber.

FIG. 1, further displays external components including the detection device 40 is displayed. The detection device may be one of several devices or models available on the market today including, but not limited to, a spectrum analyzer such as the Rohde & Schwarz FSU spectrum analyzer, a frequency counter such as the BK Precision model 103, 104 and 106, or a variety of other known, commercially available electromagnetic energy detection devices

FIG. 1, further displays the human interface display 50, which can be one of a wide variety of devices including a one of many display screens that are available on the market today. The interface could also work with other indicators such as audio warnings or warning lights.

FIG. 2, the enclosure 10 is shown with a cutaway section view to permit representation of additional elements located within the test chamber's interior. A more detailed display of the interior of the chamber including a plurality of antenna arrays 30, sealable doors 20 and 25.

In the preferred embodiment the interior antenna 30 within the test chamber include a sequencing or directionality element incorporated to provide the capacity to determine the location of the source of any energy detected. This feature allows individual antenna arrays, and directional elements located within the containment area to test for suspect items. This feature of the invention allows particular areas within the containment structure to be inspected individually so that a three dimensional location of detected item can be determined.

Commercially available devices which can adequately perform the detection device function include, but are not limited to, radio frequency counters, such as the BK Precision model 103, 104 or 106, wideband radio rrequency detectors such as the OzSpy Model RFD 5, radio frequency field detectors, memory radio analyzers and electromagnetic interference detectors, as well as others.

Each of these commercially developed devices is readily available in the marketplace. The function of each of these devices is collect and process data regarding magnetic fields, electromagnetic fields and electromagnetic radiation. Data collection units such as the Rohde & Schwarz model FSU spectrum analyzer can be used to evaluate a wide range of electromagnetic energy including, but not limited to, CDMA, W-CDMA, TDMA, GSM, PDC, PHS, WiFi and Bluetooth™ signals. The Rohde & Schwarz model FSU Spectrum Analyzer is a high-tech device and provides for a wide scanning range and fast scan time. Additionally, this device provides for interface with additional hardware to perform in a variety of scanning, reporting and functional modes.

In the preferred embodiment the collection and analysis device 40 transmits the data to a human interface device 50 for processing and presentation. In the preferred embodiment the human interface device 50 is commercially available display monitor and control device.

While the preceding provides a description of the preferred embodiment of a detection apparatus, those skilled in the art will recognize various alternative designs, embodiments and uses for the invention as presented. The uses of this invention are not limited to those presented above but also may include a variety of other applications.

What I claim is:

1. A detector system for detecting and reporting electromagnetic energy which may be associated with devices restricted from use onboard aircraft, comprising:
a) chamber means to isolate the test area from externally generated electromagnetic energy;
b) antenna means positioned within said chamber means to receive electromagnetic energy;
c) detector means connected to said antenna means for detecting said received electromagnetic energy; and
d) interface means connected to said detector means for reporting the presence of said electromagnetic energy.

2. A detector system as claimed in claim 1 wherein the test area is shielded from externally generated electromagnetic energy.

3. A detector system as claimed in claim 1 wherein the antenna means is a wide band multi-element device.

4. A detector system as claimed in claim 1 wherein the antenna means is directional so that a specific location for the source of the electromagnetic energy can be determined.

5. A detector system as claimed in claim 1 wherein the detector means for reporting any detected electromagnetic energy is connected to a human interface means for reporting the presence on said detected electromagnetic energy.

6. A detector system as claimed in claim 1 wherein the detector means for reporting any detected electromagnetic energy is connected to a communication means for reporting the presence on said detected electromagnetic energy to a remote site.

7. A detector system for detecting electromagnetic radiation comprising:
a) a chamber means to isolate the test area from externally generated electromagnetic radiation;
b) an antenna means positioned with said chamber means to receive electromagnetic radiation from a specified area;
c) a detector means connected to said antenna means for detecting said received electromagnetic radiation; and
d) an interface means connected to said detector means for reporting any electromagnetic radiation detected.

8. A detector system as claimed in claim 7 wherein the chamber is of sufficient size to fully contain a singular or plurality of aircraft unit load devices.

9. A detector system as claimed in claim 7 wherein the chamber has a singular or plurality of openings to provide for the ingress and egress of said test objects.

10. A detector system as claimed in claim 7 wherein the chamber is oriented to provide for linear transport of test objects through said chamber;

11. A detector system as claimed in claim 7 wherein the interface means is connected to recording means;

12. A method for preventing hazardous items from being introduced in to air cargo or public conveyances or other areas of concern, comprising the steps of:
a) locating a suspect item in a test chamber shielded from externally generated electromagnetic energy; and
b) detecting within the test chamber electromagnetic energy which may be associated with a device used to trigger a hazardous device; and
c) identifying said item for additional examination.

13. The method as described in claim 12 further including the step of:
isolating said item.

14. The method as described in claim 12 further including the step of:
neutralizing said hazardous device.
